(19) United States
(12) Patent Application Publication
(10) Pub. No.: US 2016/0240057 A1
(43) Pub. Date: Aug. 18, 2016

(54) SYSTEM AND METHOD FOR PROVIDING ALERTS REGARDING OCCUPANCY CONDITIONS

(71) Applicant: IPVideo Corporation, Bay Shore, NY (US)

(72) Inventor: Paul Galburt, Punta Gorda, FL (US)

(21) Appl. No.: 15/043,766

(22) Filed: Feb. 15, 2016

Related U.S. Application Data
(60) Provisional application No. 62/116,034, filed on Feb. 13, 2015.

(51) Int. Cl. G08B 13/24; G08B 13/18

(52) U.S. Cl. CPC G08B 13/2494; G08B 13/18

(57) ABSTRACT

Disclosed are a system and method for providing alerts regarding occupancy conditions. At least one analog motion detection sensor detects occupancy and/or behavior, at least one microwave motion detection sensor detects occupancy and/or behavior; and at least one sound microphone detects at least one audio frequency associated with an audio source. Motion detection information associated with occupancy and/or behavior detected by analog motion detection sensor(s) and microwave motion detection sensor(s), and audio detection information is received, and processed to determine an occupancy and/or behavior condition. The determined occupancy and/or behavior condition is compared to a baseline occupancy and/or baseline condition to establish a status of the determined occupancy and/or behavior condition. An alert is generated that represents a condition associated with the status, and is output.

### CROSS-REFERENCE TO RELATED PATENT APPLICATIONS

This application is based on and claims priority to U.S. Provisional Patent Application 62/116,034, filed Feb. 13, 2015, the entire contents of which are incorporated by reference herein as if expressly set forth in its respective entirety herein.

### FIELD

The present application relates, generally, to systems and methods associated with detecting occupancy and room conditions and, more particularly, to gathering non-visual data from a single room to detect and report on abnormalities.

### BACKGROUND

There remains a concern that unsafe conditions in environments where traditional video cameras cannot be used, such as due to privacy concerns, are not adequately detected. Traditional cameras also do not have the necessary information needed to identify unsafe conditions and require human monitoring to do so.

### BRIEF SUMMARY

In one or more implementations, a system and method provide alerts regarding occupancy conditions. At least one analog motion detection sensor detects occupancy and/or behavior, at least one microwave motion detection sensor detects occupancy and/or behavior; and at least one sound microphone detects at least one audio frequency associated with an audio source. Motion detection information associated with occupancy and/or behavior detected by analog motion detection sensor(s) and microwave motion detection sensor(s), and audio detection information is received, and processed to determine an occupancy and/or behavior condition. The determined occupancy and/or behavior condition is compared to a baseline occupancy and/or baseline condition to establish a status of the determined occupancy and/or behavior condition. An alert is generated that represents a condition associated with the status, and is output.

These and other aspects, features, and advantages of the invention can be understood with reference to the following detailed description of certain embodiments of the invention taken together in conjunction with the accompanying drawings figures.

### BRIEF DESCRIPTION OF THE DRAWINGS

FIG. 1 is a diagram illustrating a general configuration of the present application that includes zones of operation of a plurality of sensors.

FIG. 2 illustrates a simplified schematic of system components in accordance with an implementation of the present application.

FIG. 3 depicts an example implementation of an audio system design in accordance with an example implementation.

FIG. 4 depicts a system comprising motion detection firmware and its relationship to motion detection hardware.

FIG. 5 illustrates motion detection patterns associated with each of a plurality of detectors.

FIG. 6 illustrates examples of detection and timing in accordance with an example implementation.

FIG. 7 illustrates components in an example design of a detector sub-system, in accordance with one or more implementations.

FIG. 8 illustrates an example assignment of microprocessor input pins in connection with an example board architecture.

FIG. 9 illustrates an example partial circuit diagram including a set of pull-up resistors for a I2C bus.

FIG. 10 illustrates an example status graphical display that provides information on the current state of a room.

FIG. 11 is a high-level diagram of a networked configuration including components of an example computer system.

FIG. 12 is a flow diagram showing a routine that illustrates a broad aspect of a method for processing code(s) in accordance with at least one implementation of the present application.

### DESCRIPTION

The referenced systems and methods are described with reference to the accompanying drawings, in which like reference numerals refer to like elements and in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods.

The present application comprises multiple sensors, such as motion detectors, sound detectors, photodetectors or the like, which use a plurality of technologies to gather visual and non-visual data from a single room, including on a continuous basis. Data that are generated from such sources are analyzed by one or more processors specially configured by executing code to detect occupancy and/or abnormal conditions or behavior in a room. Moreover, one or more processors can be configured to generate alerts representing the conditions, and to transmit the alerts to respective computing devices. The processor(s) can be provided locally with the respective sources, or can be remotely located and receive the data via network communication components/devices.

In one or more implementations, the present application comprises a network of connected device and users, such as via 802.3AF or 802.3AT power provided over a network cable. In operation, data obtained from various sensors are gathered by a local processing system and various determinations and evaluation can be performed, such as by this same system.

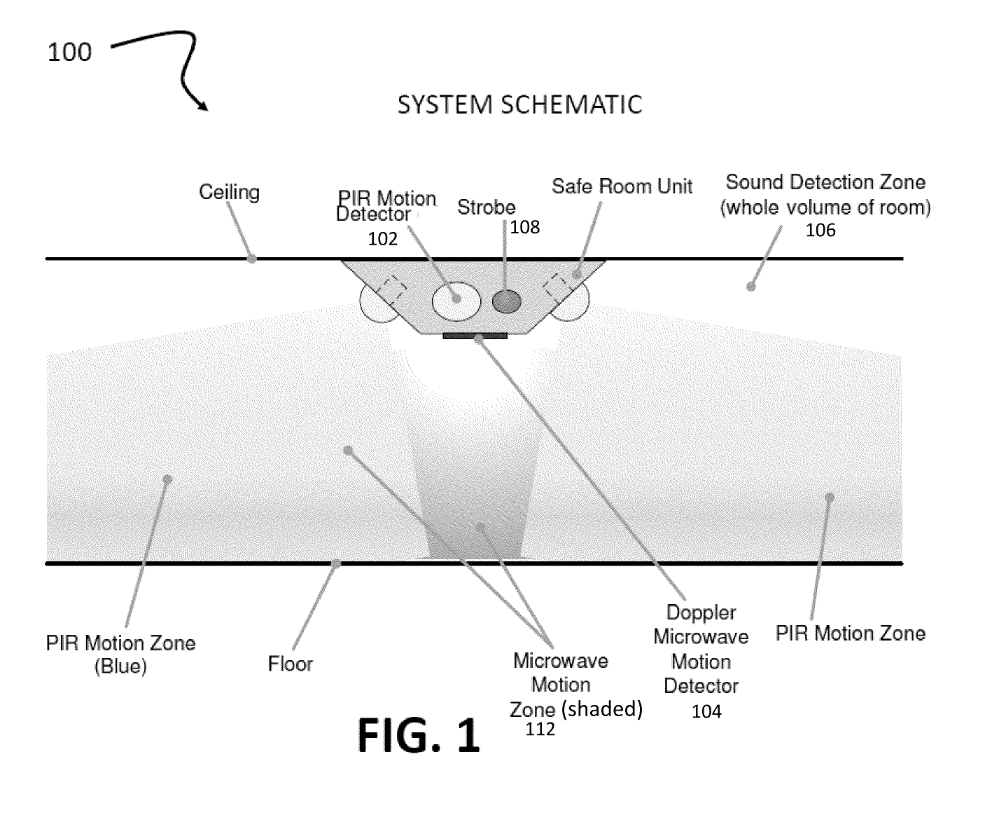

FIG. 1 is a diagram illustrating a general configuration 100 of an example implementation the present application that includes zones of operation of a plurality of sensors. Various sensors, referred to herein generally as “primary sensors,” are used to detect human occupancy and to detect and characterize abnormal human behavior. The present application incorporates multiple technologies (sensor fusion) and multiple sensors of each technology, which are more reliable than any single sensor and potentially more reliable under more conditions than any video motion detection when combined with proper algorithms in the controller-microprocessor.

Continuing with reference to FIG. 1, the present application gathers and processes data from a plurality of sensors. In the configuration shown in FIG. 1, passive infrared (“PIR”) motion detectors 102 are included, which can be of the analog type and have a 10 to 20 meter detection range. The PIR motion detectors 102 detect and occupancy and behavior, which can be characterized as being within or outside of predetermined thresholds. The PIR detectors 102 can include single area sensors or multi-pixel detectors, with or without associated processing capability. One or more sensors can be used, with a plurality of sensors being particularly suitable for localization of the motion source. In addition to PR motion detectors 102, one or more microwave Doppler motion detectors 104 can be included. Microwave Doppler motion detectors 104 can operate in the X-band (10.5 GHz) or other microwave band and have a 10 to 20 meter range, and are used to detect and characterize occupancy and behavior. As with PIR motion detectors 102, a plurality microwave Doppler motion detectors 104 are particularly suitable for determining localization of a motion source. In addition, to PIR detectors 102 and microwave Doppler motion detectors 104, sound microphones 106 can be included. Sound microphones 106 can include fast Fourier (FFT) processing to divide sound detection into 1-Octave band for discrimination of different types of events (normal activity, scream, glass break, gunshot). A single microphone or multiple microphones may be used, with multiple microphones being particularly suitable for localization of a sound source.

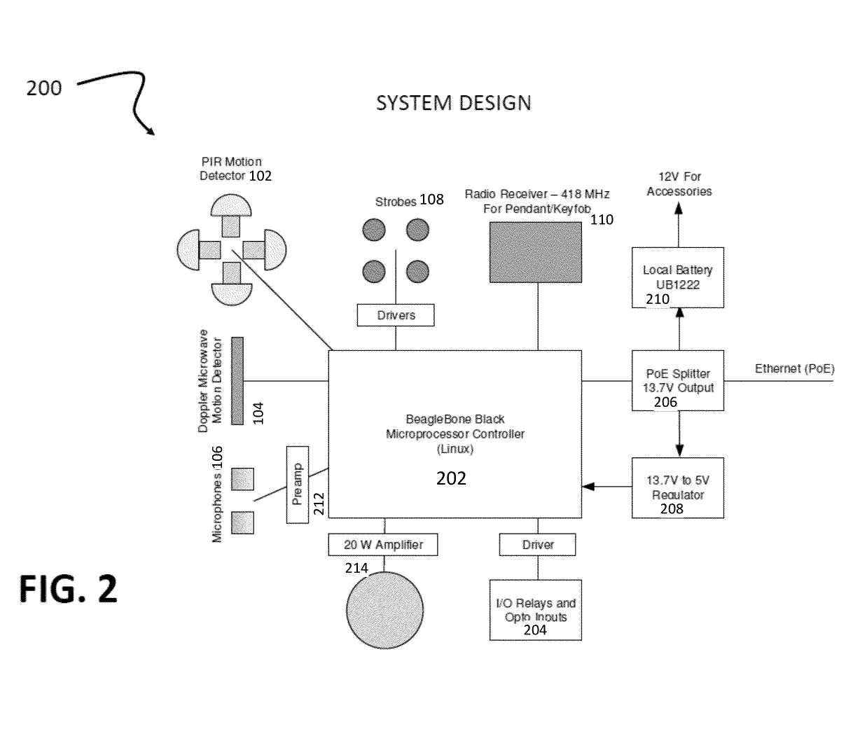

In addition to primary sensors, the present application can employ secondary sensors and output devices to take advantage of the presence of a complete networked controller, and provide useful additional functionality beyond the occupancy and behavior detection data received from the primary sensors. For example, some of this functionality can be related to environmental quality and some to emergency alerts for the occupants. The secondary sensors and output devices can include environment sensors and alerting components and systems. Example environmental sensors can detect, for example, air temperature, humidity and light levels. Various alerting components and systems can include strobes 108 (e.g., bright white), loudspeakers and an audio amplifier, such as for siren and speech alerts (not shown). Other alerting components include relays for external systems, digital inputs for external systems and a RF receiver and accessory key fob control (panic alert) 110 (FIG. 2). Thus, in addition to a primary sensor, a plurality of secondary sensor options are supported herein, as well, such as relating to CO level, CO₂ level, NO₂ level, as well as cameras and various analytics systems (not shown).

FIG. 2 illustrates a simplified schematic 200 of a plurality of system components in accordance with an implementation of the present application and including an environment referred to herein, generally, as a “Safe Room.” The specific components and features shown in FIG. 2 are exemplary, with various other types of components (e.g., microprocessors and power sources) being also supported. With regard to the microprocessor system 202, a credit-card-sized Linux-capable computer can be included that connects to a network and runs software such as Android 4.0 or Ubuntu Linux. The microprocessor system is configured with sufficient physical I/O and processing power, for example, for real-time analysis and accessing components, such as audio CODEC and Relay I/O plug-in boards 204. With regard to the power supply, a modified COTS PoE Splitter 206 can be used to derive 13.7V of DC power. This can be further adjusted using a 13.7V to 5V regulator 208 and 13.7V to 3.3V regulator modules to power the microprocessor system 202, and other low voltage components. The 13.7V power can also be applied to accessory components including the strobe 108, sounder and relays. With regard to power for surge loads, a sealed lead acid (SLA) storage battery 210 is included to supply extra power required for strobes and sonic alert/speech delivery. The 13.7V DC voltage allows float charging of the SLA battery 210. Alternatively, this battery may be omitted and the “Safe Room” device can be programmed to operate within the limits of the power available from PoE AT or, where available, PoE AT+ will allow full power operation. The primary difference being the available audio output power.

Many of the sensors can be connected directly or indirectly to the A/D inputs or digital inputs of the microprocessor system 202. Some devices, such as the strobe 108, sounder and relays utilize 13.7V power at higher current levels and can have MOSFET drivers to connect them. Certain sensors such as various gas detectors require controlled heating for proper calibration. These will also utilize MOSFET drivers and PWM control. Furthermore, in order to obtain suitable dynamic range and frequency range for audio sensing, alerting and public address, microphones 106 can be pre-amplified (212) and then processed through a separate high quality audio CODEC on a cape plugged into the processor. This CODEC is also capable of high quality audio output that will be used to drive a high powered (20 watts) amplifier and PA speakers 214 for both alert siren and PA speech functions. Audio can be analyzed by applying real-time fast Fourier transform (“FFT”) to divide in bands, each band with its own level readout. Moreover and in connection with environmental (secondary) sensors, light level, temperature, humidity, and tilt connections, as well as optional gas sensors (not shown) can be a combination of analog inputs and I2C data bus connections.

Moreover, the present application can utilize firmware that can provide several layers of processing to achieve a desired performance. For example, sensor inputs can be captured and converted, including FFT operation on the audio and a frequency counter for the output of the microwave motion sensor. One or more processors can apply a self-learning decision-making algorithm and apply inputs to the algorithm. Steps can include: check algorithm outputs with certainty thresholds; configure the algorithm to implement threshold outputs; connect the algorithm outputs to the web stack to deliver alarms to central server; provide remote control and monitoring of secondary functions; provide system health monitoring and implement over-the-network firmware updates.

In one or more implementations, firmware implements a learning mode in which the algorithm or other self-learning topology is “programmed,” such as by learning what the sensor readings are in a room and representing a “normal” condition. Accordingly, a baseline is established that is usable to determine when conditions occur that fall outside of the baseline. Minimally, this is all the setup that is required. Any condition that appears outside of the baseline and, accordingly, that does not “seem” like a normal room is an alert. In the module the network will also provide an output for unoccupied. Further, the firmware also implements data transmission and alert thresholds for conventional environmental or wired sensors and I/O. Further, the “Safe Room” system can implement network security and encryption when various selections of these features are incorporated in an implementation of the present application.

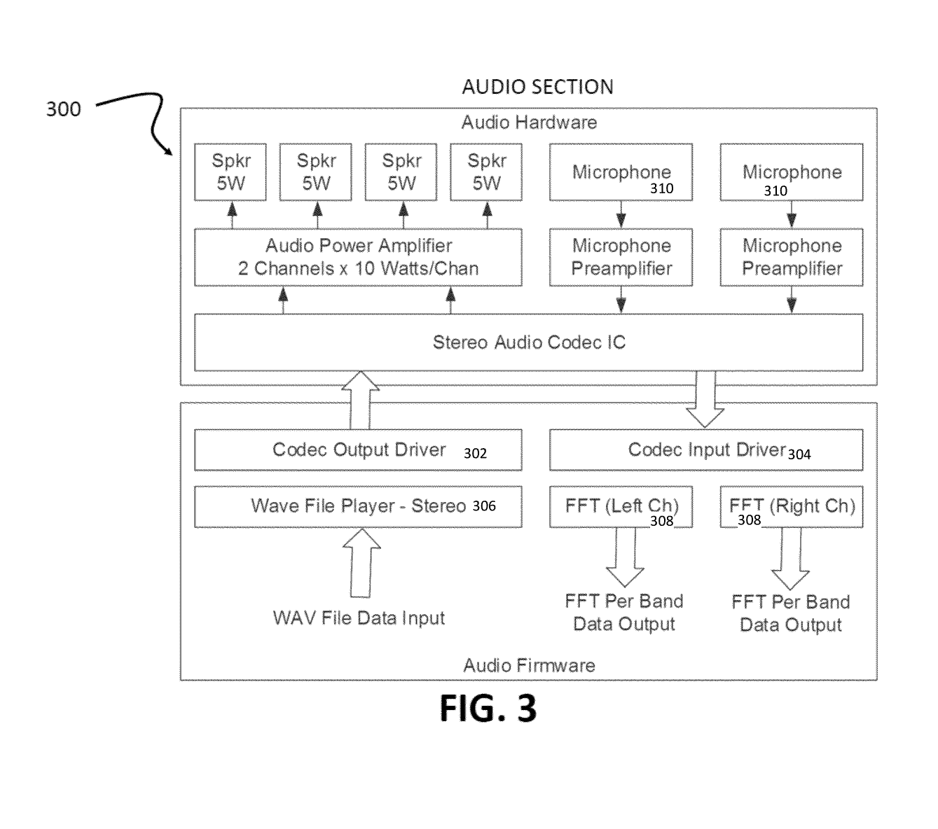

FIG. 3 depicts an example implementation of an audio system design 300 that includes audio firmware and its relationship to the audio hardware in accordance with one or more implementations. Of course, other designs may be used including analog filter rather than FFT and larger or smaller audio amplifiers. With regard to audio firmware, the present application can include a Codec Output Driver 302, an Amplifier Configuration Driver, a Codec Input Driver, an audio player 306 (e.g., Wave File Player), and a FFT 308. The Codec Output Driver 302 can configure the CODEC output hardware element for operation at 44 Kbps sampling rate and 16-bit dynamic range. This configuration choice may be derived from the overall system configuration file that can be uploaded from a remote network source. The Amplifier Configuration Driver can include a MAX9744 audio amplifier that is connected to the I2C bus (as described herein) of the microprocessor and can be the primary tool for transferring data between the controller and the amplifier. A driver function can be provided that loads configuration information from the configuration file into the Amplifier. The driver isolates information providing processes from corresponding protocols and data requirements associated with the physical or logistical details of the amplifier.

In one or more implementations, the codec input driver 304 configures the CODEC input hardware element for operation at 44 Kbps sampling rate and 16-bit dynamic range and stereo (2-channel) operation. This configuration choice can be derived from the overall system configuration file that can be uploaded from a remote network source. Further, an audio file player 306 (e.g., a Wave File Player) is operable to point to a WAV file in memory storage and present that file for proper playback by the Codec Output driver 302. The player 306 accepts messages that indicate which file to play, what sample rate and bit depth to expect, and how many times to loop the file before stopping. The player 306 can also implement an immediate stop command. A dynamic volume control (level multiplier fraction) is also useful. With regard to FFT 308 (Left and Right Channels), the digitized audio input from each microphone 310 can be processed through a firmware FFT analysis routine to develop a set of outputs with numeric values that correspond to the audio levels of each of the bands defined for the FFT 308. The (2) arrays of these frequency/value pairs will be made available to subsequent anomaly detection processes. The configuration of the Left and Right FFT 308 channels can be determined by parameters for number of bands, band frequency centers, processing bit depts., and processing rate. These parameters can be derived from a configuration file that is uploaded to the system.

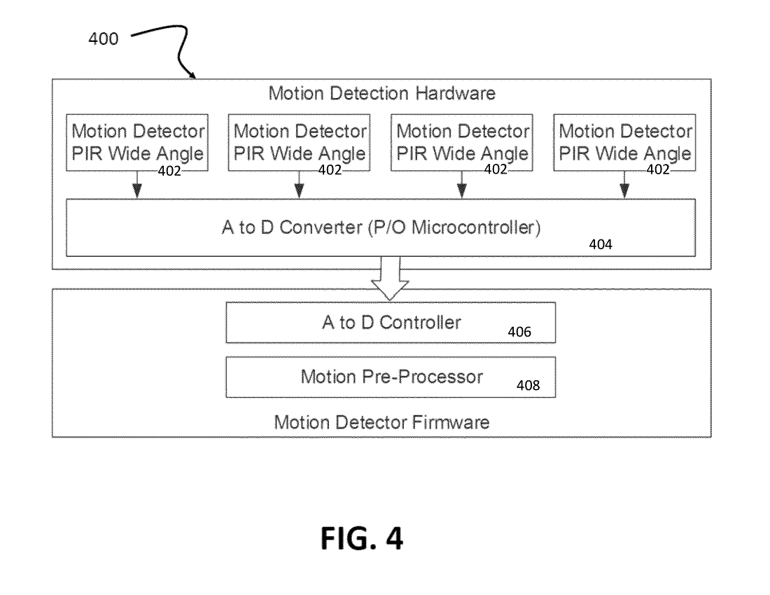

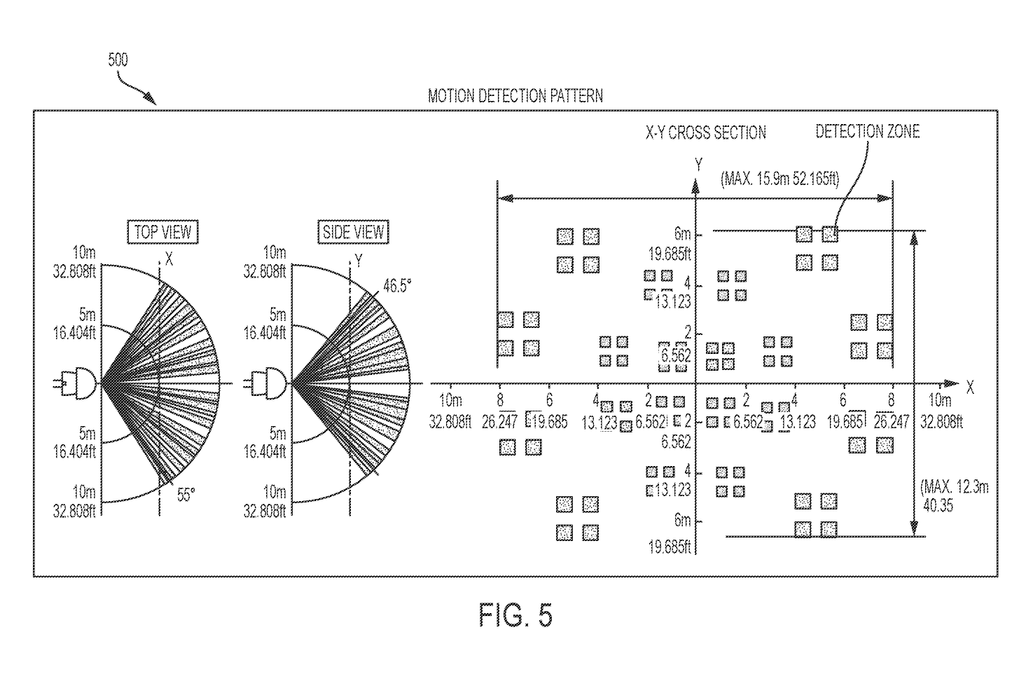

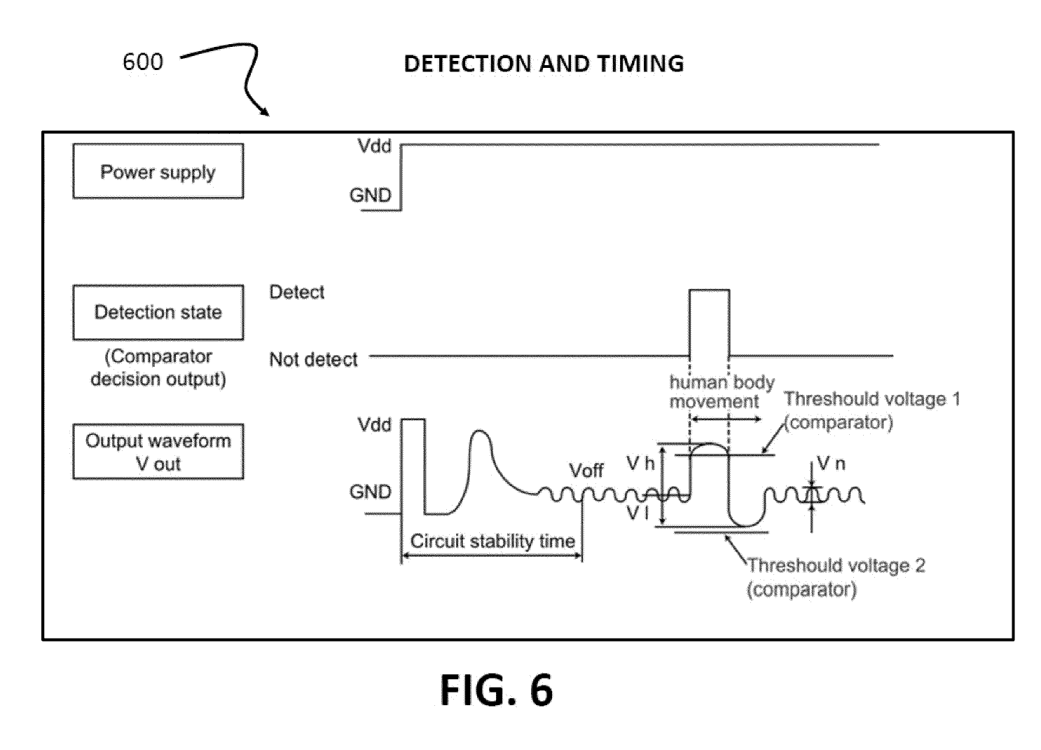

FIG. 4 depicts a system 400 comprising motion detection firmware and its relationship to motion detection hardware. In operation, motion detection is provided by long range wide angle multi-zone PIR detectors 402 (e.g., 4 detectors). Each detector 402 has a pattern of detection 500 as shown in FIG. 5. In one or more implementations, the four detectors 402 can be arranged in the four compass directions and tilted down 45 degrees from horizontal to provide full room coverage. The 90 degree horizontal angle just fills a circle while the 110 degree vertical angle ensures full coverage at the walls. The coverage is divided into multiple beams and a person moving from beam to beam causes detectable voltage output. FIG. 6 illustrates specifics 600 of detection and timing.

Continuing with reference to FIG. 4, in connection with PIR motion detection firmware requirements, an analog to digital converter control generalized routine 404 operates an A to D controller 406 and to provide conversion values of the available inputs (e.g., 7 inputs) at a rate determined by a value in the configuration file. This routine is can be interrupt driven to enable the processing of incoming A to D data as a background task. Regarding, PIR motion detection pre-processing, a set of functions processes the raw data from the (4) A to D channels that represent the PR motion detector 408 outputs. A function can be provided that allows averaging of the A to D output over a period of time as a first order noise filter. This averaging time is a configuration value. Further, a function can be provided that implements a delay of 10's of seconds after a system power cycle that allows the PR detectors 402 to stabilize before processing the output data. This time delay is a configuration value. A function can also be provided that, when applied by one or more processors, results in an indication to be generated and transmitted representing that arrangements have been made for “no active motion or occupancy” so that the baseline output voltage of the sensors can be measured and stored.

Further, a function can be implemented by one or more processors to extract the amplitude, duration and inter-peak interval of the detection peaks (time since last detected peak), as shown in FIG. 6. These output values can be computed each time a peak is detected and made available for further processing. The pre-processor output is a matrix of the (4) detector outputs for these (3) parameters.

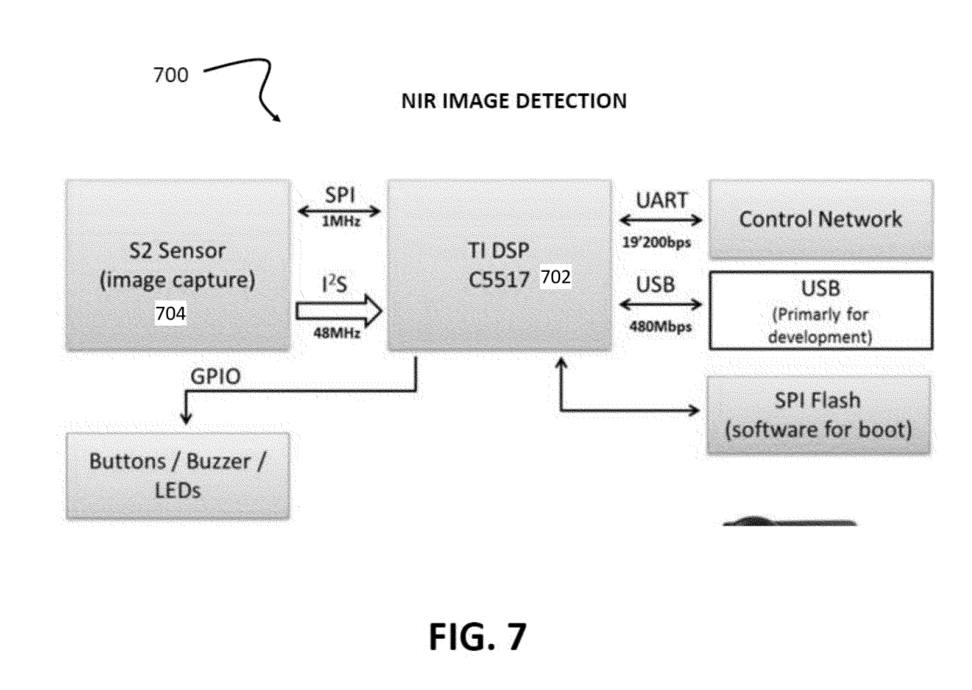

In an alternative implementation, near infra-red motion and occupancy detection in lieu of or in addition to PR motion detection shown and described above. In such case, the (e.g., 4) PIR detectors 402 can be replaced by a single VGA resolution NIR imager equipped with a fisheye lens covering the entire room area. An example design of such detector sub-system 700 is shown in FIG. 7. The sensor can include a dedicated DSP IC 702 to handle image processing functions. The processing for the sensor 704 divides the visual area into, for example, 9 or 16 separate cells. The processing routines report values of occupancy, motion amount and motion direction for each of these cells. These output values are then applied as inputs to the neural network in place of the four (4) outputs of the PR motion detectors 402 that are replaced.

In one or more implementations, microwave motion detection 112 (FIG. 1) is employed that includes an X-Band motion sensor that is constructed of two boards connected by posts: a control board, and the antenna PCB with the Doppler sensor. When the enable pin is either held high or left floating, the control board cycles the Doppler sensor's power at 2 kHz, 4% duty cycle. The Doppler sensor's 10.525 GHz oscillator signal is routed to a Tx antenna, and also to a mixer diode. The mixer diode's IF output contains signals with the sum and difference of the transmitted and received frequencies along with components of the original signal and some harmonics.

The difference signal's frequency that results from mixing the outgoing and returning signal frequencies oscillates at a frequency corresponding to how much the returning signal has been either compressed or stretched as a result of the Doppler Effect that an object has on the signal as the object moves toward or away from the sensor. It is recognized by the inventor that the device is quite stable but also quite sensitive. The antenna, for example, has a wide area of coverage. The frequency of the square wave output ranges from 10 Hz to 250 Hz depending on the speed of the moving person detected.

With regard to microwave motion detection firmware, the detector 104 can be connected to two (2) digital pins of the microprocessor. One pin can be configured as an output and enables or disables the microwave emitter in the detector. A function can be provided, which allows controlling the state of this pin. The other pin can be configured as a digital input and a function can be provided which returns the frequency of the output of the detector based on a rolling average of the number of low to high transitions taken over an interval set by the configuration file (nominal 1000 mS). This function can be called by another process.

Further and with regard to illumination sensing, an illumination sensor can be employed, which is an advanced device that has a very large dynamic range, pseudo human eye response, and other features that make it useful for the present application.

In one or more implementations, a TSL2561 integrated circuit is employed, which is a light-to-digital converter that transforms light intensity to a digital signal output capable of direct I2C interface. Each device can combine one broadband photodiode (visible plus infrared) and one infrared-responding photodiode on a single CMOS integrated circuit capable of providing a near-photopic response over an effective 20-bit dynamic range (16-bit resolution). Two integrating ADCs convert the photodiode currents to a digital output that represents the irradiance measured on each channel. This digital output can be input to a microprocessor where illuminance (ambient light level) in lux is derived using an empirical formula to approximate the human eye response.

The TSL2561 device supports a traditional level-style interrupt that remains asserted until the firmware clears it. Use of this interrupt is optional in the development of the firmware driver for this TSL2561. With regard to illumination driver firmware and operation, the illumination detector can be connected to the I2C bus of the microprocessor, which is a means of transferring data between the controller and the detector. A driver function can be provided that extracts information from the sensor and makes that information conveniently available to other processes. The driver serves to isolate information consuming processes from information regarding the physical or logistical details of the sensor.

The driver uses the I2C address of the sensor to connect to it correctly over the I2C bus. Since this address is determined by the design of the device and the address configuration set in hardware, it can be embedded in the driver code and need not be a configuration variable.

The driver gets information from the sensor by polling it on a regular basis and maintaining the latest values in accessible memory buffers. The polling rate is determined by a supplied configuration value. Depending on the system design, the driver may also include high and low thresholds that are set as either fixed values or percentages of rolling average values maintained by the driver. These thresholds are evaluated after each polling actions and set flags or trigger other processes when crossed. The threshold values and rolling average durations are provide by configuration values. An optional part of the design is the use of the hardware interrupt provided by the TSL2561 device. This interrupt is triggered whenever the light level is above a user-set upper threshold or below a user-set lower threshold. While this method may eliminate the need for polling, it may not provide sufficient data for analytics and operation in accordance with the present application.

Further and in connection with temperature and humidity sensing, a temperature and humidity sensor can be provided to track values for the room where it is installed. The HTU21D(F) is a digital humidity sensor with temperature output by Measurement Specialties (“MEAS”), for example. This sensor provides calibrated, linearized signals in digital, I²C format. Direct interface with a micro-controller is made possible with the module for humidity and temperature digital outputs. Every sensor can be individually calibrated and tested. Lot identification is printed on the sensor and an electronic identification code is stored on the chip, which can be read out by command. Further, a low battery can be detected and a checksum improves communication reliability. The resolution of these digital humidity sensors can be changed by command (8/12 bit up to 12/14 bit for RH/T).

In one or more implementations, a temperature and humidity (“T&H”) detector is connected to the I2C bus of the microprocessor, which is useful for transferring data between the controller and the detector. A driver function can be provided that extracts information from the sensor and makes that information conveniently available to other processes. The driver can serve to isolate information consuming processes from any knowledge of the physical or logistical details of the sensor. In one or more implementations, the driver needs to know the I2C address of the sensor in order to connect to it correctly over the I2C bus. Since this address is determined by the design of the device and the address configuration set in hardware, it can be embedded in the driver code and need not be a configuration variable. In operation, the driver gets information from the sensor by polling it on a regular basis and maintaining the latest temperature and humidity values in accessible memory buffers. The polling rate is determined by a supplied configuration value.

In one or more implementations, an anti-tamper accelerometer is provided, which is a 3-Axis accelerometer for use primarily as an anti-tamper device. Once the detection is armed, any attempt to remove the components from an installed location, open a case, or physically damage a unit enclosure results in an immediate alert. For example, an MMA8451Q is a smart, low-power, three-axis, capacitive, micro-machined accelerometer with 14 bits of resolution. This accelerometer can include embedded functions with flexible user programmable options, configurable to two interrupt pins. Embedded interrupt functions allow for overall power savings relieving the host processor from continuously polling data. Access to both low-pass filtered data as well as high-pass filtered data is provided, which minimizes the data analysis required for jolt detection and faster transitions. The device can be configured to generate inertial wakeup interrupt signals from any combination of the configurable embedded functions allowing the MMA8451Q to monitor events and remain in a low-power mode during periods of inactivity.

With regard to relays and digital inputs, relay outputs and digital inputs can be handled by a relay switch interface. The following features are included: 2 high current relays (NO, COM, NC) with status LEDs; 4 high current outputs (with status LEDs); 4 Pushbutton switches; 4 Input (5V tolerant, up to 12V); User LED (Blue) for status or debug; Output voltage selection (3.3V or 5V); R/C servo motor output; 2 Analog inputs (potentiometer and battery monitor); and screw terminal connectors (simplifies external connections).

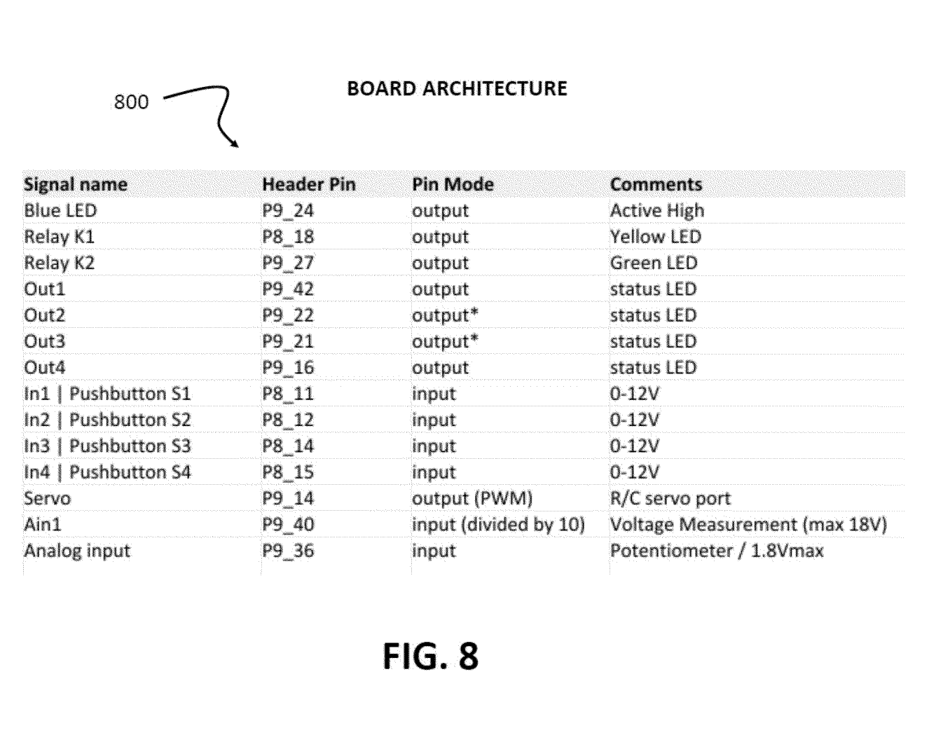

FIG. 8 illustrates microprocessor input pins 800 in connection with an example board architecture.

With regard to relay and input driver firmware, a driver for this device can provide functions that open, close or pulse the relays, as dictated by other processes. The driver polls the related inputs and provides values that represent the state of the switches and allow switch state changes to trigger other firmware processes.

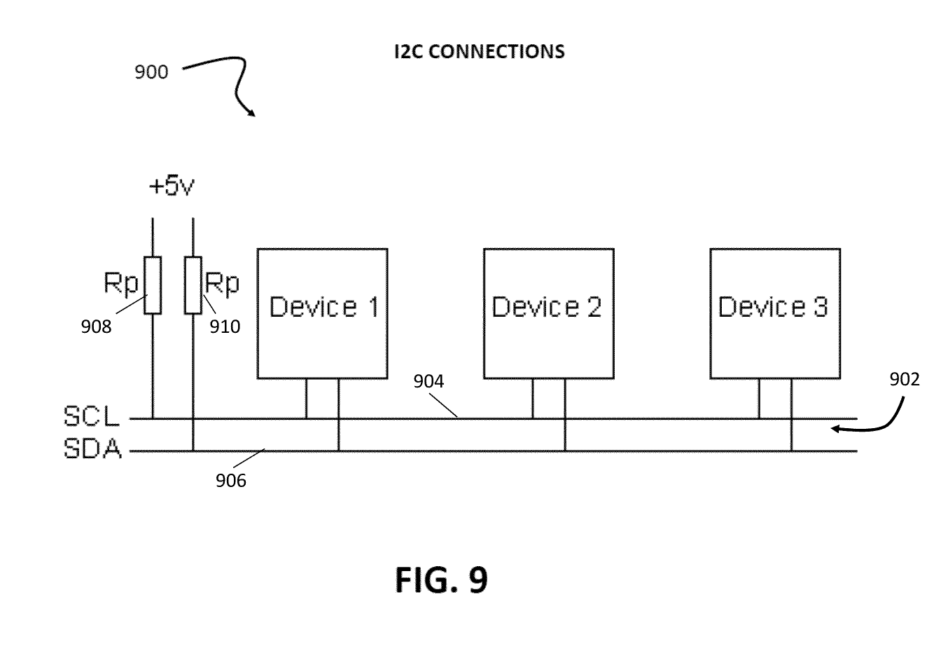

Referring to FIG. 9 and with regard to I2C Bus Communication 900, an I2C bus 902 passes data between the microcontroller and several of the sensors and output subsystems in accordance with one or more implementations. The physical I2C bus topology can include two dedicated wires (circuits): SCL 904 and SDA 906. SCL 904 is the clock line and used to synchronize data transfers over the I2C bus. SDA 906 is the data line. The SCL 904 and SDA 906 lines are connected to all devices on the I2C bus. Both SCL 904 and SDA 906 lines are “open drain” drivers, in that the chip drives its output low, but not high. For the line to be able to go high the design provides pull-up resistors to the 5 v supply. For example, a resistor 908 is provided from the SCL line to the 5 v line and another resistor 910 from the SDA line to the 5 v line. Accordingly, the implementation shown in FIG. 9 includes a set of pull-up resistors 908, 910 for the I2C bus 902, not for each device. The values of these resistors can be 2200 ohms, which provides a good balance between bus speed and power consumption. Devices 1-3 on the I2C bus can be configured as masters or slaves. For example, the master device drives the SCL 904 clock line, and slaves respond to the master. In one or more implementations and unlike a master device, a slave cannot initiate a transfer over the I2C bus 902. In one or more implementations, multiple slaves can be provided on the I2C bus 902 with one master. Both master and slave devices can transfer data over the I2C bus 902, which is typically controlled by the master. Moreover, in one or more implementations, the microcontroller can be the master.

In an example operation, when the master (e.g., the controller) talks to a slave (the illumination sensor, for example) the master begins by issuing a start sequence on the I2C bus 902. A start sequence can be one of two special sequences defined for the I2C bus 902, the other being the stop sequence. In one or more implementations, the start sequence and stop sequence are special in that these are the only places where the SDA 906 (data line) is allowed to change while the SCL 904 (clock line) is high. When data is being transferred, SDA remains stable and does not change whilst SCL is high. The start and stop sequences mark the beginning and end of a transaction with the slave device.

Regarding occupancy and alert detection, an algorithm can be implemented in the control microprocessor to evaluate the levels from the various sensors and set flags that indicate occupancy and/or warning or alert conditions. The algorithm can include logical connections for the inputs and outputs thereof. For example and in connection with detection, motion detection values or values from pixel-based sensors (e.g., 4 values), (1) Microwave detection Doppler shift frequency, FFT derived frequency band sound levels (possibly 2 sets from 2 microphones, possibly 7 total), light level, occupation schedule, detection algorithm outputs, unscheduled occupancy, scheduled occupancy with a few people, scheduled occupancy with many people, excessive activity and alarm activity values are construed.

In one or implementations, the algorithm can be implemented as part of the microprocessor firmware. Inputs are available in memory and output can be directly connected to the alerting logic and web services. Additional algorithm controls can include the timing signal for processing and the setting for learning mode. In general the algorithm timing is synchronized with the gathering of data from the sensors so that fresh values are presented to the inputs just before algorithm processing. Further, a provision is provided to store all of the learned weighting coefficients and functions as a file which may be uploaded from one or more units and downloaded into others to accelerate the learning process.

In connection with a configuration process, unit configuration information can be stored in a file that can be uploaded from and downloaded to the device using a network connection. This file design can include a checksum to ensure against corruption and a double buffering mechanism to a complete download and check before the file is installed. This buffering includes the ability keep the current version in memory during a download and to return to this last operational version if the download causes a malfunction.

An example file includes data and parameters for the following: configuration of all sensors; configuration of sound system; logic for local alerting functions; algorithm weighting parameters and functions; date/time schedule(s); audio (sound) files (e.g., in WAV format) for information and alerting purposes are stored in the flash memory card associated with the microprocessor and are separately downloaded by an external process. These files can be indexed for referencing in an application programming interface (API) and Local Rules.

The local rules can include connection of the local strobe and audio alerts to the outputs of an artificial neural network (“ANN”) or with thresholds to native sensor values. These functions can also be connected to general purpose inputs or outputs (GPIO) for external sensing and control applications. Each rule can include an input selection, threshold as applicable, output selection, schedule for applicability, duration of output action for each triggering event, and hold off time after a triggering event. The output of a rule can include an email or API push action with content including the source and source state that triggered the rule. Rules can be triggered on threshold crossing in a particular direction or be valid once threshold is crossed in a particular direction.

Schedules can be based on active days of week and active times during the day with 1 minute resolution. Schedules also include an organizational tag like “vacation” or “show” or a specific single Date or Date range. The API can include a parameter to set the mode of the unit to match one of these tags to active the schedules with that tag.

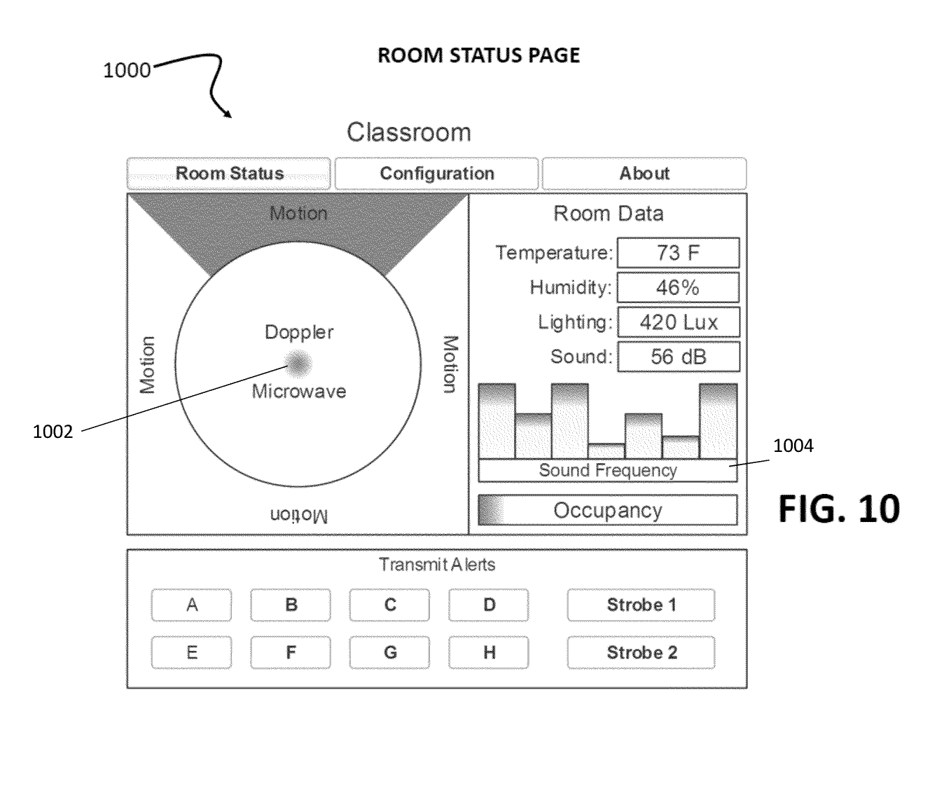

In one or more implementations, a web-based user interface is provided that provide various functionality, including to configure basic settings using typical web browser software. FIG. 10 illustrates an example status page 1000 that provides information on the current state of a room (“Classroom”), largely in graphical form. As shown in FIG. 10, the detected motion is display in four quadrants that correspond to the actual geometry of the device. Color shift toward a respective color, e.g., red, indicates increasing motion. The output of the Doppler Microwave is indicated by the size of the colored (e.g., red) dot 1002 in the center of the circle. The numeric values from the environmental sensors are displayed at the right. The levels of each of the FFT bands are displayed in the Sound Frequency graph and the computed occupancy is displayed on a horizontal bar graph 1004. Buttons A-H are provided for manual activation of several available sonic alerts and recorded instructions as well as strobe patterns. Of course, alternative displays are envisioned and supported herein.

In addition to a status page, a “configuration page” can be provided (not shown) and used to set up one or more devices, and that include, for example: server IP address; server port; server user ID; server password; user DHCP; local IP address; local port; local user ID; local password; allow remote firmware upgrade [T/F]; enable local security [T/F]; defaults will be designed to allow local connection for initial configuration. In addition to a status page, an “about page” can be provided for, for example, company information, hardware model information, and firmware version.

With regard to the API, functionality in accordance with the present application of can be primarily configured, controlled and accessed through the Web Services REST API. The functionality of the API can be divided into three (3) sections: Configuration; Status; and Alerts.

The configuration information can be contained in a single XML file that includes all required settings and values for the operation of all functions except those values involved with addressing and contacting the central Server. The API includes functions that allow transferring this file to and from a remote server as commanded from the server side. The internal operation includes buffering (storing) this file in the device during an inbound transfer and performing an integrity check before replacing the “old” settings. The “old” settings are also stored so that the device can return to the previous (working) settings if it fails to work with the new settings. This return can be commanded through the API or by a local physically controlled process.

In one or more implementations, the API enables a server to request current status values from one or more of the sensors. The design has variable granularity so that a single web services request can contain a list of one or many sensors with the result returned as a snippet of XML or JSON. In general the server can poll the devices for status data, with the more critical data being polled more frequently but with no data being polled more frequently then perhaps every 15 seconds. The status API provides comprehensive data suitable for examination and logging but is not intended for alarm actions.

Further, alerts can comprise data delivered to the Server in a timely manner. Alert data can be the result of the output of rules or processes within the device that generally involve a value or sensed behavior crossing a preset threshold. Alerts can be transmitted as small snippets of XML or JSON, which are pushed by the device to an accessible web service on the Server. Alert transmissions can be provided for timely warning and alarm messages which are expected only infrequently. In one or more implementations, such transmissions are not under control of the central server, and use of this mechanism for general status messages can result in overloading the central server due to random bunching as well as delivery of substantial unnecessary data. ONVIF can be employed, which is an open industry forum for the development of a global standard for the interface of IP-based physical security products. ONVIF is committed to the adoption of IP in the security market. The ONVIF specification will ensure interoperability between products regardless of manufacturer. The cornerstones of ONVIF are: Standardization of communication between IP-based physical security Interoperability between IP-based physical security products regardless of manufacturer Open to all companies and organizations. Moreover, the ONVIF specification defines a common protocol for the exchange of information between network video devices including automatic device discovery, video streaming and intelligence metadata. The use of ONVIF profile C as an alternate interface for alert transmissions enables direct interoperability with any third party video management system (VMS) or physical security management system (PSIM) that supports the profile for alert messages, without the need for a special integration programming or connectors. The development of this interface includes the examination of several leading VMS products to determine the level and details of support for ONVIF Profile C and building an embedded connection class module that routes Safe Room alerts through the ONVIF Profile C protocol to these VMS and PSIM systems. Configurations data can include a section for storing connection and authentication values for this external ONVIF system.

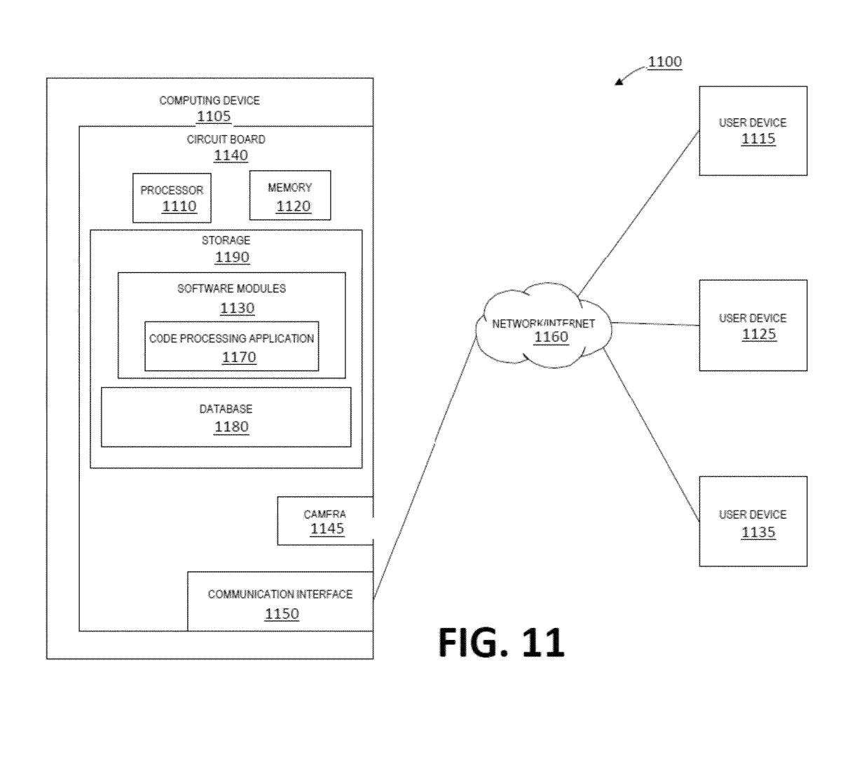

An exemplary computer system is shown as a block diagram in FIG. 11 which is a high-level diagram illustrating an exemplary configuration of a system 1100. Computing device 1105 can be a personal computer or server, or can be a mobile computing device, such as a tablet computer, a laptop computer, a smartphone or other suitable computing device. Thus, it is to be understood that computing device 1105 of system 1100 can be practically any computing device and/or data processing apparatus capable of embodying the systems and/or methods described herein.

Computing device 1105 of system 1100 can include a circuit board 1140, such as a motherboard, which is operatively connected to various hardware and software components that serve to enable operation of the system 1100. The circuit board 1140 can be operatively connected to a processor 1110 and a memory 220. Processor 1110 serves to execute instructions for software that can be loaded into memory 1120. Processor 1110 can be a number of processors, a multi-processor core, or some other type of processor, depending on the particular implementation. Further, processor 1110 can be implemented using a number of heterogeneous processor systems in which a main processor is present with secondary processors on a single chip. As another illustrative example, processor 1110 can be a symmetric multi-processor system containing multiple processors of the same type.

Preferably, memory 1120 and/or storage 1190 are accessible by processor 1110, thereby enabling processor 1110 to receive and execute instructions stored on memory 1120 and/or on storage 1190. Memory 1120 can be, for example, a random access memory (RAM) or any other suitable volatile or non-volatile computer readable storage medium. In addition, memory 1120 can be fixed or removable. Storage 1190 can take various forms, depending on the particular implementation. For example, storage 1190 can contain one or more components or devices such as a hard drive, a flash memory, a rewritable optical disc, a rewritable magnetic tape, or some combination of the above. Storage 1190 also can be fixed or removable.

One or more software modules 1130 are encoded in storage 1190 and/or in memory 1120. The software modules 1130 can comprise one or more software programs or applications having computer program code or a set of instructions executed in processor 1110. Such computer program code or instructions for carrying out operations for aspects of the systems and methods disclosed herein can be written in any combination of one or more programming languages, including an object oriented programming language such as Java, Smalltalk, C++, Python, and JavaScript or the like and conventional procedural programming languages, such as the “C” programming language or similar programming languages. The program code can execute entirely on computing device 1105, partly on computing device 1105, as a stand-alone software package, partly on computing device 1105 and partly on a remote computer/device, or entirely on the remote computer/device or server. In the latter scenario, the remote computer can be connected to computing device 1105 through any type of network, including a local area network (LAN) or a wide area network (WAN), or the connection can be made to an external computer (for example, through the Internet 1160 using an Internet Service Provider).

One or more software modules 1130, including program code/instructions, are located in a functional form on one or more computer readable storage devices (such as memory 1120 and/or storage 1190) that can be selectively removable. The software modules 1130 can be loaded onto or transferred to computing device 1105 for execution by processor 1110. It can also be said that the program code of software modules 1130 and one or more computer readable storage devices (such as memory 1120 and/or storage 1190) form a computer program product that can be manufactured and/or distributed in accordance with the present invention, as is known to those of ordinary skill in the art.

It is to be understood that, in some illustrative embodiments, one or more of software modules 1130 can be downloaded over a network to storage 1190 from another device or system via communication interface 1150 for use within system 1100. For instance, program code stored in a computer readable storage device in a server can be downloaded over a network from the server to system 1100.

Moreover, the software modules 1130 can include a code processing application 1170 that is executed by processor 1110. During execution of the software modules 1130, and specifically the code processing application 1170, the processor 1110 configures the circuit board 1140 to perform various operations relating to code processing with computing device 1105, as will be described in greater detail below.

Furthermore, it is to be understood that while software modules 1130 and/or code processing application 1170 can be embodied in any number of computer executable formats, in certain implementations software modules 1130 and/or code processing application 1170 comprise one or more applications that are configured to be executed at computing device 1105 in conjunction with one or more applications or ‘apps’ executing at remote devices, such as computing device(s) 1115, 1125, and/or 1135 and/or one or more viewers such as internet browsers and/or proprietary applications. Furthermore, in certain implementations, software modules 1130 and/or code processing application 1170 can be configured to execute at the request or selection of a user of one of computing devices 1115, 1125, and/or 1135 (or any other such user having the ability to execute a program in relation to computing device 1105, such as a network administrator), while in other implementations computing device 1105 can be configured to automatically execute software modules 1130 and/or code processing application 1170, without requiring an affirmative request to execute. It should also be noted that while FIG. 11 depicts memory 1120 oriented on circuit board 1140, in an alternate arrangement, memory 1120 can be operatively connected to the circuit board 1140. In addition, it should be noted that other information and/or data relevant to the operation of the present systems and methods (such as database 1180) can also be stored on storage 1190, as will be discussed in greater detail below.

Continuing with reference to FIG. 11, storage 1190 can store database 1180. As described in greater detail below, database 1180 can contain and/or maintain various data items and elements that are utilized throughout the various operations of system 1100. Although database 1180 is depicted in FIG. 11 as being configured locally to computing device 1105, in certain implementations database 1180 and/or various of the data elements stored therein can be located remotely (such as on a remote device or server—not shown) and connected to computing device 1105 through network 1160, in a manner known to those of ordinary skill in the art.

As referenced above, it should be noted that in certain implementations, such as the one depicted in FIG. 11, various ones of the computing devices 1115, 1125, 1135 can be in periodic or ongoing communication with computing device 1105 through a computer network, such as the Internet 1160.

Continuing with reference to FIG. 11, communication interface 1150 is illustrated as also operatively connected to circuit board 1140. Communication interface 1150 can be any interface that enables communication between the computing device 1105 and external devices, machines and/or elements. Preferably, communication interface 1150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting computing device 1105 to other computing devices and/or communication networks such as private networks and the Internet. Such connections can include a wired connection or a wireless connection (e.g. using the 802.11 standard) though it should be understood that communication interface 1150 can be practically any interface that enables communication to/from the circuit board 1140.

At various points during the operation of system 1100, computing device 1105 can communicate with one or more computing devices, for example, those controlled and/or maintained by one or more individuals and/or entities, such as user devices 1115, 1125, and/or 1135. Such computing devices can transmit and/or receive data to/from computing device 1105, thereby initiating maintaining, and/or enhancing the operation of the system 1100. The computing devices 1115-1135 can be in direct communication with computing device 1105, indirect communication with computing device 1105, and/or can be communicatively coordinated with computing device 1105. While such computing devices can be practically any device capable of communication with computing device 1105, in certain embodiments various of the computing devices are servers, while other computing devices are user devices (e.g., personal computers, handheld/portable computers, smartphones, etc.) and, thus, that practically any computing device that is capable of transmitting and/or receiving data to/from computing device 1105 can be suitable.

Moreover, while FIG. 11 depicts system 1100 with respect to computing devices 1115, 1125, and 1135, virtually any number of computing devices can interact with the system 1100 in a manner described herein. It should be further understood that a substantial number of operations shown and described herein can be initiated by and/or performed in relation to such computing devices. For example, as referenced above, such computing devices can execute applications and/or viewers that request and/or receive data from computing device 1105, substantially in the manner described in detail herein.

The present application includes certain embodiments and/or arrangements reference to acts and symbolic representations of operations that are performed by one or more devices, such as shown and described in the system 1100 of FIG. 11. Such acts and operations, which are at times referred to as being computer-executed or computer-implemented, can include manipulation by the processor 1110 of electrical signals representing data in a structured form. This manipulation transforms the data and/or maintains them at locations in the memory system of the computer (such as memory 1120 and/or storage 1190), which can reconfigure and/or otherwise alter the operation of the system in a manner understood by those skilled in the art. The data structures in which data are maintained can be physical locations of the memory that have particular properties defined by the format of the data. Of course, one skilled in the art will recognize that this not meant to provide architectural limitations to the manner in which different embodiments can be implemented. The different illustrative embodiments can be implemented in a system including components in addition to or in place of those illustrated for the system 1100. Other components shown in FIG. 11 can be varied from the illustrative examples shown. The different embodiments can be implemented using any suitable hardware device or system capable of running program code. In another illustrative example, system 1100 can take the form of a hardware unit that has circuits that are manufactured or configured for a particular use. This type of hardware can perform operations without requiring program code to be loaded into a memory from a computer readable storage device to be configured to perform the operations.

For example, computing device 1105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 1130 can be omitted because the processes for the different embodiments are implemented in a hardware unit.

In still another illustrative example, computing device 1105 can be implemented using a combination of processors found in computers and hardware units. Processor 1110 can have a number of hardware units and a number of processors that are configured to execute software modules 1130. In this example, some of the processors can be implemented in the number of hardware units, while other processors can be implemented in the number of processors.

In another example, a bus system can be implemented and can be comprised of one or more buses, such as a system bus or an input/output bus. Of course, the bus system can be implemented using any suitable type of architecture that provides for a transfer of data between different components or devices attached to the bus system. Additionally, communications interface 1150 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types. While the various computing devices and machines referenced herein, including but not limited to computing device 1105, computing devices 1115, 1125, and 1135, are referred to herein as individual/single devices and/or machines, in certain implementations the referenced devices and machines and their associated and/or accompanying operations, features, and/or functionalities can be arranged or otherwise employed across any number of devices and/or machines, such as over a network connection.

Furthermore and although not all illustrated in FIG. 11, various additional components can be incorporated within and/or employed in conjunction with computing device 1105. For example, computing device 1105 can include an embedded and/or peripheral image capture device such as a camera 1145 and/or an embedded and/or peripheral audio capture device such as a microphone.

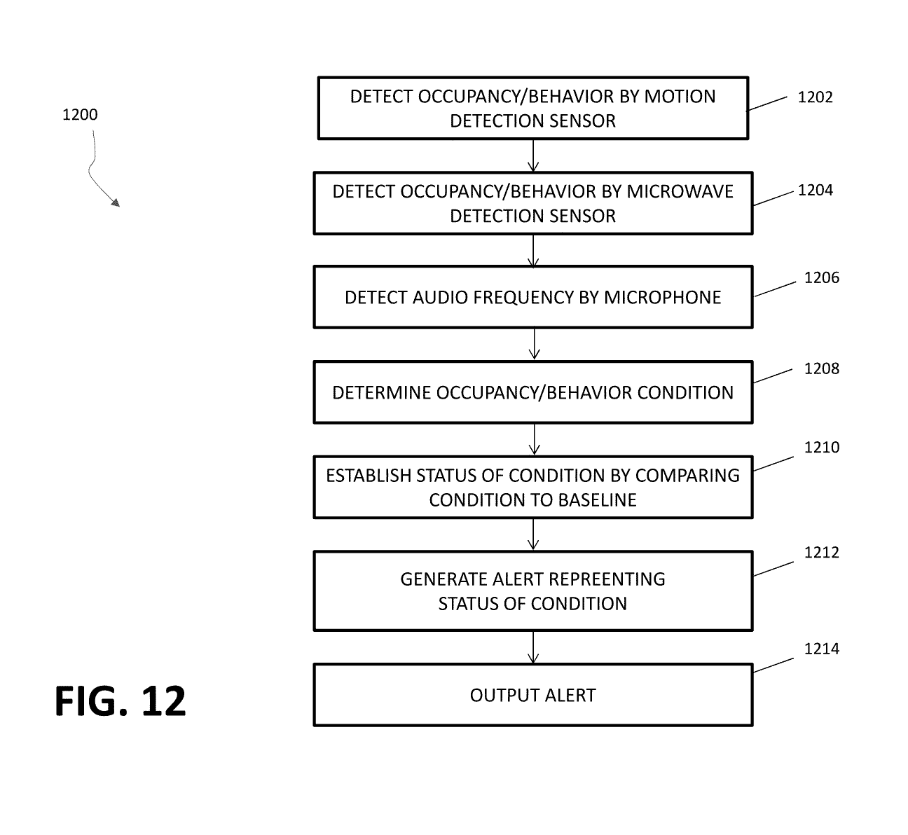

Turning now to FIG. 12, a flow diagram is described showing a routine 1200 that illustrates a broad aspect of a method for processing code(s) in accordance with at least one embodiment disclosed herein. Several of the logical operations described herein are implemented (1) as a sequence of computer implemented acts or program modules running on computing device and/or (2) as interconnected machine logic circuits or circuit modules within one or more computing devices. The implementation is a matter of choice dependent on the requirements of the device (e.g., size, energy, consumption, performance, etc.). Accordingly, the logical operations described herein are referred to variously as operations, steps, structural devices, acts, or modules. Various of these operations, steps, structural devices, acts and modules can be implemented in software, in firmware, in special purpose digital logic, and any combination thereof. Furthermore, more or fewer operations can be performed than shown in the figures and described herein. These operations can also be performed in a different order than those described herein.

Continuing with reference to FIG. 12, as noted herein and in at least one implementation, occupancy and/or behavior is detected by at least one analog motion detection sensor (step 1202), and by at least one microwave motion detection sensor (step 1204). Further at least one audio frequency is detected by a microphone (step 1206). At least one processor receives information associated with the detected occupancy/behavior information and information associated with the at least one audio frequency. The information is processed to determine an occupancy and/or behavior condition (step 1208). At step 1210, a status of the condition is determined as a function of a comparison of the determined occupancy/behavior condition with a baseline. Thereafter, an alert is generated that represents status of the determined condition (step 1212). The alert is, thereafter, output by the at least one processor (step 1214). Thereafter, the process ends (not shown).

Thus, as shown and described herein a system and method are provided that include multiple sensors, such as motion detectors, sound detectors, photodetectors or the like, and that gather visual and non-visual data. Occupancy and/or abnormal conditions or behavior in a room are determined accordingly and alerts representing the conditions can be generated and transmitted to respective computing devices. The processor(s) can be provided locally with the respective sources, or can be remotely located and receive the data via network communication components/devices.

Although illustrated embodiments of the present invention have been shown and described, it should be understood that various changes, substitutions, and alterations can be made by one of ordinary skill in the art without departing from the scope of the present invention.

What is claimed is:

1. A system for providing alerts regarding occupancy conditions represented by at least non-visual data, the system comprising:
at least one analog motion detection sensor configured to detect occupancy and/or behavior;
at least one microwave motion detection sensor configured to detect occupancy and/or behavior; and
at least one sound microphone configured detect at least one audio frequency associated with an audio source;
processor readable media that is configured to store information associated with each of the sensors and the at least one sound microphone;
at least one processor configured to receive:
motion detection information associated with occupancy and/or behavior detected by the at least one analog motion detection sensor;
motion detection information associated with occupancy and/or behavior detected the at least one microwave motion detection sensor; and
audio detection information associated with the at least one audio frequency detected by the at least one sound microphone;
wherein the processor readable media is further configured to store instructions that, when executed by the at least one processor, cause the at least one processor to:
and process the received motion detection information and the received audio detection information to determine an occupancy and/or behavior condition;
compare the determined occupancy and/or behavior condition to a baseline occupancy and/or baseline condition stored in the processor readable media to establish a status of the determined occupancy and/or behavior condition;
generate an alert that represents a condition associated with the status; and
output the alert.

2. The system of claim 1, further comprising at least one environmental sensor respectively configured to detect at least one of air temperature, humidity, light level, CO level, CO₂ level, NO₂ level and visual content.

3. The system of claim 1, wherein the alert is output to one or more of:
at least one light strobe;
at least one loudspeaker;
at least one input to an external system; and
at least one computing device.

4. The system of claim 1, wherein the analog motion detection sensor is a PIR motion detector.

5. The system of claim 1, wherein audio detected by the at least one sound microphone is divided into bands as a function of fast fourier processing.

6. The system of claim 1, wherein the baseline is established by the processor as a function of processing previously received motion detection information and audio detection information.

7. The system of claim 1, wherein the audio detection information represents at least one of a plurality of events.

8. The system of claim 7, wherein the at least one of the plurality of events includes normal activity, a scream, a gunshot, and glass breaking.

9. The system of claim 1, further comprising an interactive Internet web site that is configured with a status page, a configuration page and an information page associated with hardware and software.

10. A method for providing alerts regarding occupancy conditions represented by at least non-visual data, the method comprising:
detecting, by at least one analog motion detection sensor, occupancy and/or behavior;
detecting, by at least one microwave motion detection sensor occupancy and/or behavior; and
detecting, by at least one sound microphone, at least one audio frequency associated with an audio source;
providing processor readable media that is configured to store information associated with each of the sensors and the at least one sound microphone;
receiving, by at least one processor:
motion detection information associated with occupancy and/or behavior detected by the at least one analog motion detection sensor;
motion detection information associated with occupancy and/or behavior detected the at least one microwave motion detection sensor; and
audio detection information associated with the at least one audio frequency detected by the at least one sound microphone;
processing, by the at least one processor, the received motion detection information and the received audio detection information to determine an occupancy and/or behavior condition;
comparing, by the at least one processor, the determined occupancy and/or behavior condition to a baseline occupancy and/or baseline condition stored in the processor readable media to establish a status of the determined occupancy and/or behavior condition;
generating, by the at least one processor, an alert that represents a condition associated with the status; and
outputting, by the at least one processor, the alert.

11. The method of claim 10, further comprising detecting, by at least one environmental sensor, at least one of air temperature, humidity, light level, CO level, CO₂ level, NO₂ level and visual content.

12. The method of claim 10, wherein the alert is output to one or more of:
at least one light strobe;
at least one loudspeaker;
at least one input to an external system; and
at least one computing device.

13. The method of claim 10, wherein the analog motion detection sensor is a PIR motion detector.

14. The method of claim 10, wherein audio detected by the at least one sound microphone is divided into bands as a function of fast fourier processing.

15. The method of claim 10, wherein the baseline is established by the processor as a function of processing previously received motion detection information and audio detection information.

16. The method of claim 10 wherein the audio detection information represents at least one of a plurality of events.

17. The method of claim 16, wherein the at least one of the plurality of events includes normal activity, a scream, a gunshot, and glass breaking.

18. The method of claim 10, further comprising providing an interactive Internet web site that is configured with a status page, a configuration page and an information page associated with hardware and software.
